(19) United States
(12) Patent Application Publication
(10) Pub. No.: US 2013/0239690 A1
(43) Pub. Date: Sep. 19, 2013

(54) MRE EXCITATION APPARATUS, EXCITATION SYSTEM, AND EXCITATION METHOD

(71) Applicants: Shigeru Tadano, Sapporo-shi (JP); Itsuro Kajiwara, Sapporo-shi (JP); Kazuhiro Fujisaki, Sapporo-shi (JP); Seishin Takao, Sapporo-shi (JP); Gen Nakamura, Sapporo-shi (JP); Yu Jiang, Sapporo-shi (JP); Mikio Suga, Chiba-shi (JP)

(72) Inventors: Shigeru Tadano, Sapporo-shi (JP); Itsuro Kajiwara, Sapporo-shi (JP); Kazuhiro Fujisaki, Sapporo-shi (JP); Seishin Takao, Sapporo-shi (JP); Gen Nakamura, Sapporo-shi (JP); Yu Jiang, Sapporo-shi (JP); Mikio Suga, Chiba-shi (JP)

(73) Assignee: NATIONAL UNIVERSITY CORPORATION CHIBA UNIVERSITY, Chiba-shi (JP)

(21) Appl. No.: 13/818,964

(22) PCT Filed: Aug. 25, 2011
(86) PCT No.: PCT/JP2011/069215

§ 371 Date: May 8, 2013

(30) Foreign Application Priority Data
Aug. 25, 2010 (JP) 2010-188514

(51) Int. Cl. G01N 29/04

(52) U.S. Cl. CPC G01N 29/04
USPC 73/644

(57) ABSTRACT

An MRE excitation apparatus (100) comprises an excitation device (110) that generates vibration, and a transmitter (120) that is made using a non-magnetic material and that, with one end-section being fastened to the excitation device (110) and the other end-section being connected with a living body (300), and that extends in direction that vibration is transmitted from the excitation device (110) and transmits longitudinal vibration from the excitation device (110) to the living body (300). The frequency of the vibration is 125 Hz or greater, the amplitude of the vibration is 0.2 mm or greater, and the primary natural frequency of the longitudinal vibration of the transmitter (120) is further on the higher side than the frequency band of the vibration from the excitation device (110).

### 1. TECHNICAL FIELD

The present invention relates to an MRE excitation apparatus, excitation system and excitation method for exciting a test object during Magnetic Resonance Elastography (MRE) measurement.

### 2. BACKGROUND ART

As methods for exciting a test object (object that is being tested) such as a body during MRE measurement, there are methods that use piezoelectric elements, and there are methods that use sound pressure. In a method that uses a piezoelectric element, such as disclosed in Unexamined Japanese Patent Application Kokai Publication No. 2005-118406, a body is excited by pressing a piezoelectric element against the surface of the body. Moreover, in an excitation method that uses sound pressure, such as disclosed in National Patent Publication No. 2008-501416, a body is excited by way of a probe that is attached to the tip end of a tube and transmitting a longitudinal wave vibration of air that is generated by an acoustic speaker through the tube.

### CITATION LIST

### Patent Literature

Patent Literature 1: Unexamined Japanese Patent Application Kokai Publication No. 2005-118406
Patent Literature 2: National Patent Publication No. 2008-501416

### SUMMARY OF INVENTION

### Technical Problem

In MRE measurement it is necessary to vibrate the surface of the test object using an excitation apparatus, and to cause that vibration to propagate to the area of the object being measured (deep inside the body). However, in conventional excitation methods that use a piezoelectric element, the amount of displacement of the piezoelectric element was minute at only a few microns. Moreover, even in the case of a piezoelectric element actuator in which a plurality of piezoelectric elements are arranged in series, the amount of displacement is only several tens of microns, so that it was not possible to obtain sufficient amplitude for MRE measurement. Furthermore, in excitation methods that use sound pressure, the longitudinal vibration of the air is dampened while propagating through the inside of the tube, making it impossible to obtain sufficient amplitude during MRE measurement.

Taking the problems above into consideration, it is the objective of the present invention to provide an MRE excitation apparatus, excitation system and excitation method that are capable of vibrating a test object with an sufficient excitation amplitude during MRE measurement.

### Solution to Problem

In order to accomplish the objective above, an MRE excitation apparatus according to a first aspect of the present invention is

an MRE excitation apparatus that excites a test object during MRE measurement, and comprises:

an excitation device that generates vibrations; and

a transmitter that is made using a non-magnetic material and that, with one end-section being fastened to the excitation device and the other end-section connecting to the test object, extends along the direction of vibration from the excitation device and transmits longitudinal vibration from the excitation device to the test object; wherein

the frequency of the vibration is 125 Hz or greater;

the amplitude of the vibration is 0.2 mm or greater; and

the primary natural frequency of the longitudinal vibration of the transmitter is further on the high side than the frequency band of the vibration from the excitation device.

An MRE excitation apparatus according to a second aspect of the present invention is

an MRE excitation apparatus that excites a test object during MRE measurement, and comprises:

an excitation device that generates a vibration;

a transmitter that is made using a non-magnetic material and extends along the direction that vibration is transmitted from the excitation device;

at least one direction changer; and

a transmitter on the test object side that is made using a non-magnetic material and that extends in an angle different than the direction that the transmitter extends; wherein

the one end-section of the transmitter is fastened to the excitation device, the other end-section of the transmitter is connected to the direction changer, and the transmitter transmits longitudinal vibration from the excitation device to the direction changer;

the direction changer changes the direction of the longitudinal vibration that is transmitted by the transmitter, and transmits the longitudinal vibration to the transmitter on the test object side;

the transmitter on the test object side is connected with the test object, and transmits the longitudinal vibration to the test object;

the frequency of the vibration is 125 Hz or greater;

the amplitude of the vibration is 0.2 mm or greater; and

the primary natural frequency of the longitudinal vibration of the transmitter and the transmitter on the test object side is further on the high side than the frequency band of the vibration from the excitation device.

The transmitter may be made using a non-metallic material.

The transmitter may be made using a GFRP material.

There may also be a support that is located between the one end-section and the other end-section of the transmitter, and that supports the transmitter.

The support may be made using a soft material, and have a holder that holds the transmitter.

An MRE excitation system according to a third aspect of the present invention is

an MRE excitation system that excites a test object during MRE measurement, and comprises:

an excitation device that generates vibration; and

a transmitter that transmits a longitudinal vibration from the excitation device to the test object; wherein

the frequency of the vibration is 125 Hz or greater;

the amplitude of the vibration is 0.2 mm or greater;

the primary natural frequency of the longitudinal vibration of the transmitter is further on the high side than the frequency band of the vibration from the excitation device; and

during MRE measurement, the frequency and amplitude of the longitudinal vibration that is generated by the excitation device is controlled so that variation in measurement values of the modulus of elasticity in the measurement area in the test object is minimized.

It is also possible to comprise a controller that automatically controls the frequency and amplitude of the vibration.

An MRE excitation method according to a fourth aspect of the present invention comprises

controlling the frequency and amplitude of the vibration so that variation in measurement values of the modulus of elasticity in a measurement area in a test object is minimized;

generating a vibration; and

exciting the test object with the vibration; wherein

the frequency of the vibration is 125 Hz or greater; and

the amplitude of the vibration is 0.2 mm or greater.

The controlling the frequency and amplitude of the vibration may be automatically controlled.

### Advantageous Effects of Invention

With the present invention, it is possible to provide an MRE excitation apparatus, excitation system and excitation method that are capable of vibrating a test object with a sufficient excitation amplitude.

### BRIEF DESCRIPTION OF DRAWINGS

FIG. 1 is a drawing for explaining an example of using an MRE excitation apparatus of a first embodiment of the present invention;

FIG. 2 is a drawing summarizing the construction of an MRE excitation apparatus of embodiments of the present invention;

FIG. 3 is a drawing for explaining a 5 Gauss line;

FIG. 4A is a drawing illustrating the relationship between the specific modulus of elasticity and the natural frequency (primary) for a plurality of transmitter lengths, and FIG. 4B is a drawing illustrating the physical properties and vibration transmission characteristics for various materials;

FIG. 5 is a partial cross-sectional drawing of a transmitter and a support in section A-A in FIG. 2;

FIG. 6 is a perspective view for explaining an example of using an MRE excitation apparatus of another embodiment of the present invention;

FIG. 7 is a cross-sectional view of a direction changer in another embodiment of the present invention;

FIG. 8 is a drawing illustrating another form of a changer in another embodiment of the present invention;

FIG. 9 is a block diagram illustrating automatic control of the frequency and amplitude of vibration;

FIG. 10 is a flowchart illustrating the flow of automatic control of the frequency and amplitude of vibration;

FIG. 11 is a flowchart explaining an MRE excitation method;

FIG. 12A is a drawing illustrating the input waveform and output waveform in a verification experiment, and FIG. 12B is a drawing illustrating a comparison of measurement results and theoretical values of the amplitude amplification ratio values in the verification experiment;

FIG. 13 is a drawing illustrating experimental results of directional change of the longitudinal vibration by a direction changer;

FIG. 14 is a drawing illustrating experimental results of MRE measurement; and

FIG. 15 is a drawing illustrating experimental results of MRE measurement.

### DESCRIPTION OF EMBODIMENTS

In the following, embodiments of the present invention will be explained with reference to the drawings.

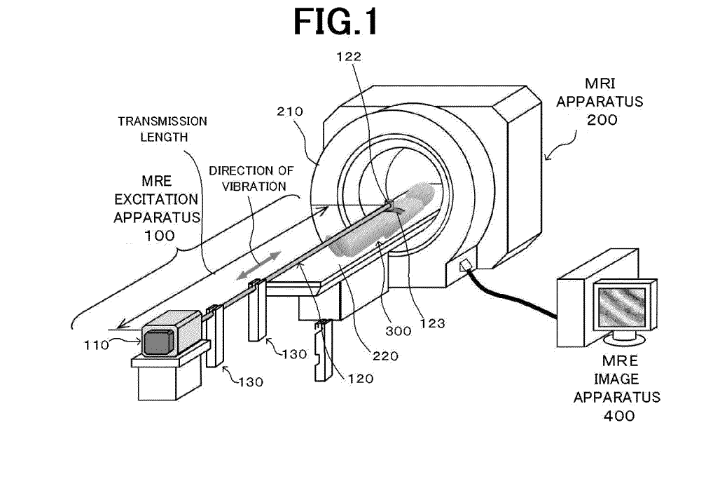

FIG. 1 is a drawing for explaining an example of a use of an MRE excitation apparatus 100 (excitation apparatus for MRE) of an embodiment of the present invention. In a method of noninvasive imaging of the tissue of an object by Magnetic Resonance Imaging (MRI), the MRE excitation apparatus 100 of this embodiment is used for applying a mechanical vibration to the test object and performing MRE measurement that qualitatively and/or quantitatively measures dynamic characteristics such as the modulus of elasticity in the tissue of the test object. More specifically, as illustrated in FIG. 1, a bed 220 is provided so that part thereof can enter inside a gantry 210 of a MRI apparatus 200, and a living body 300, which is one example of a test object, is placed on the bed 220. The body 300 is excited by an MRE excitation apparatus 100, and a signal that is obtained by the MRI apparatus 200 is analyzed by an MRE image apparatus 400 (image apparatus for MRE), and the elastic properties of the living body 300 are obtained by making it possible to visualize that signal. In MRE measurement, construction other than the MRE excitation apparatus 100 of this embodiment is the same as the conventional construction disclosed, for example, in Unexamined Japanese Patent Application Kokai Publication No. 2005-118406 and National Patent Publication No. 2008-501416, so a detailed explanation of that construction is omitted. The entire specifications, claims and drawings of Unexamined Japanese Patent Application Kokai Publication No. 2005-118406 and National Patent Publication No. 2008-501416 are incorporated in this specification by reference.

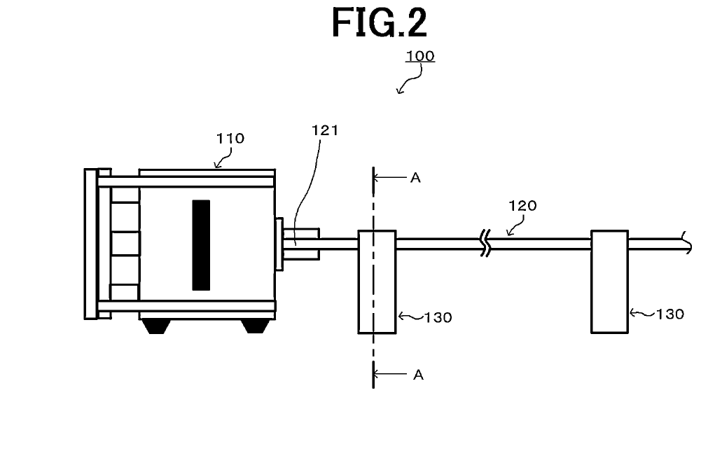

FIG. 2 is a drawing summarizing the construction of an MRE excitation apparatus 100 of this embodiment. As illustrated in FIG. 2, the MRE excitation apparatus 100 comprises, for example, an excitation device 110, a transmitter 120, and a support 130.

The excitation device 110 generates vibration. The direction (propagation direction) of the vibration that is generated by the excitation device 110 is, for example, a horizontal direction such as illustrated in FIG. 1. In a specified frequency band (for example, 50 to 250 Hz) as the excitation frequency band, the excitation device 110 is able to generate vibration having an amplitude that is equal to or greater than a specified amplitude (for example, 0.2 mm) that is sufficient for exciting the body 300. As this kind of excitation device 110, it is possible to employ, for example, a continuously variable electro-dynamic exciter that obtains an excitation force by supplying an alternating current to a driving coil that is located inside a ferromagnetic field that is generated by a permanent magnet or an exciting coil, and is capable of automatically controlling the frequency within a range of 1 to 500 Hz, and preferably within a range of 50 to 250 Hz, and controlling the amplitude within a range of 0.2 mm to 2.0 mm, and preferably within a range of 0.2 mm to 1.0 mm.

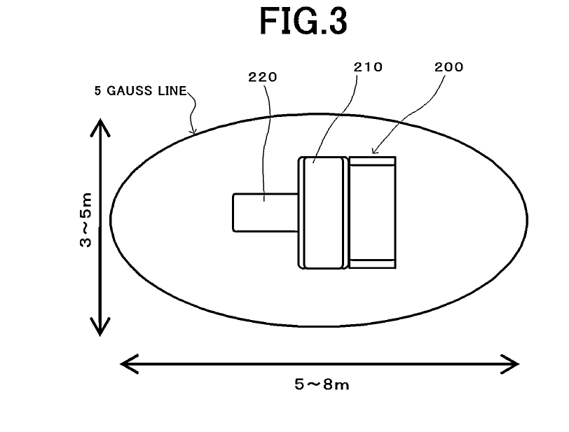

Here, the installation position of the excitation device 110 will be explained. The excitation device 110, due to the effect of the magnetostatic field of the MRI apparatus 200, cannot be placed near the MRI apparatus 200. Therefore, in the MRE excitation apparatus 100 of this embodiment, the excitation device 110 is placed at a location that is separated far enough from the MRI apparatus 200 so as to not receive the effect on the magnetostatic field, and the vibration that is generated by the excitation device 110 is transmitted by way of the transmitter 120 to the living body 300 inside the MRI apparatus 200. More specifically, the installation position of the excitation device 110 is set based on the intensity of the stray magnetic field from the MRI apparatus 200. Typically, as illustrated in FIG. 3, a 5 Gauss line that indicates the region where the intensity of the stray magnetic field is 5 Gauss or greater is regulated for the MRI apparatus 200. Normally, locations on the outside of the 5 Gauss line do not affect the operation of precision equipment such as heart pacemakers. Therefore, in this embodiment, the excitation device 110 is located on the outside of the 5 Gauss line.

The transmitter 120 vibrates longitudinally due to the vibration generated by the excitation device 110, and transmits that longitudinal vibration to the living body 300. Due to the necessity for the vibration to propagate well into the living body 300, the transmitter 120 transmits longitudinal vibration, in which the propagation direction and vibration direction coincide with, to the living body 300. The transmitter 120, for example, is formed into a cylindrical shape, and as illustrated in FIG. 2, extends from the end-section 121 on the excitation device side that is fastened to the excitation device 110 in the direction of vibration of the excitation device 110, or in other words, in the horizontal direction in FIG. 1. Here, the direction of vibration of the excitation device 110 is the same as the direction in which the vibration propagates through the transmitter 120. As illustrated in FIG. 1, an end-section 122 on the test object side, which is the end-section on the opposite side from the excitation device 121, is connected to the living body 300 by a belt 123 that is wrapped around the abdominal area of the living body 300 such that the longitudinal vibration of the transmitter 120 is transmitted to the living body 300. Moreover, the length of the transmitter 120 is set according to the installation location of the excitation device 110 with respect to the living body 300 inside the MRI apparatus 200. In other words, the length of the transmitter 120 has a specified length (for example, 3 m) that corresponds to the distance, for example, between the excitation device 110 that is located on the outside of the 5 Gauss line illustrated in FIG. 3 and the living body 300 inside the MRI apparatus 200. However, the length of the transmitter 120 is not limited to this value, and can be appropriately set to correspond with the intensity of the magnetostatic field of the MRI apparatus 200.

Next, the material of the transmitter 120 will be explained. Three conditions for the material of the transmitter 120 are as follows: (1) vibration from the excitation device 110 can be transmitted to the living body 300 without being dampened; (2) the primary natural frequency of the longitudinal vibration is on the high side from the excitation frequency band; and (3) the material is a non-magnetic material.

First, the condition that, (1) vibration from the excitation device 110 can be transmitted to the living body 300 without being dampened, will be explained. In the MRE excitation apparatus 100 of this embodiment, this condition is satisfied by taking advantage of an amplitude magnification phenomenon in the transmitter 120. The amplitude magnification phenomenon will be explained below.

The amplitude of the vibration that is generated by the excitation device 110 is amplified when transmitted by the transmitter 120, and as a result, the vibration amplitude (output amplitude) that is outputted to the living body 300 from the end-section 122 on the test object side is greater than the vibration amplitude (input amplitude) of the excitation device 110. Here, this phenomenon is called the amplitude magnification phenomenon. The amplitude magnification phenomenon will be explained from theoretical analysis of longitudinal vibration. When the transmitter 120 is modeled such that the length is L, the outer diameter is d, the inner diameter is dᵢ (0≦dᵢ<d), the density is ρ, the modulus of elasticity is E, the cross-sectional area is A, and the moment of inertial of area I for a hollow cylinder is used, the longitudinal vibration of the transmitter 120 can be expressed by the following expression.

$$ρ \frac{{\partial }^{2} u}{\partial {t}^{2}} = E \frac{{\partial }^{2} u}{\partial {x}^{2}} \qquad [ Expression 1 ]$$

Here, u is the displacement in the axial direction of the transmitter 120. The amplification factor α (output amplitude/input amplitude) of the displacement amplitude at the tip end of the shaft when the shaft is excited at a frequency f is as expressed by the following expression.

$$α ( f ) = \vert {cos}^{- 1} ( 2 π fL \sqrt{\frac{ρ}{E}} ) \vert \qquad [ Expression 2 ]$$

As illustrated by Expression 2, the amplitude amplification factor α is expressed by a function of the excitation frequency f, length L and specific modulus of elasticity E/ρ. Therefore, in order to transmit the vibration from the excitation device 110 to the living body 300 without being damped, the material of the transmitter 120 should be selected so as to have a specific modulus of elasticity that results in an amplitude amplification factor α being 1.0 or greater in the excitation frequency band.

Next, that condition that, (2) the primary natural frequency of the longitudinal vibration is on the high side from the excitation frequency band, will be explained. Here, when the transmitter 120 is such that the length is L, the density is ρ, and the modulus of elasticity is E, the n-th natural frequency fₙₛ of the longitudinal vibration of the transmitter 120 is expressed by the following expression.

$${f}_{ns} = \frac{2 n + 1}{4 L} \sqrt{\frac{E}{ρ}} = \frac{2 n + 1}{4} \frac{1}{L} \sqrt{\frac{E}{ρ}} ( n = 0 , 1 , 2 , … ) \qquad [ Expression 3 ]$$

As illustrated in Expression 3, the natural frequency of the longitudinal vibration is expressed as a function of the length L and specific modulus of elasticity E/ρ. In this embodiment, by assuming that the length L of the transmitter 120 has been set in advance by setting the installation location of the excitation device 110, the material of the transmitter 120 should be selected so as to have a specific modulus of elasticity that results in the primary natural frequency of the longitudinal vibration being separated on the high side from the excitation frequency band. As a result, it is possible to prevent damage due to resonance of the transmitter 120.

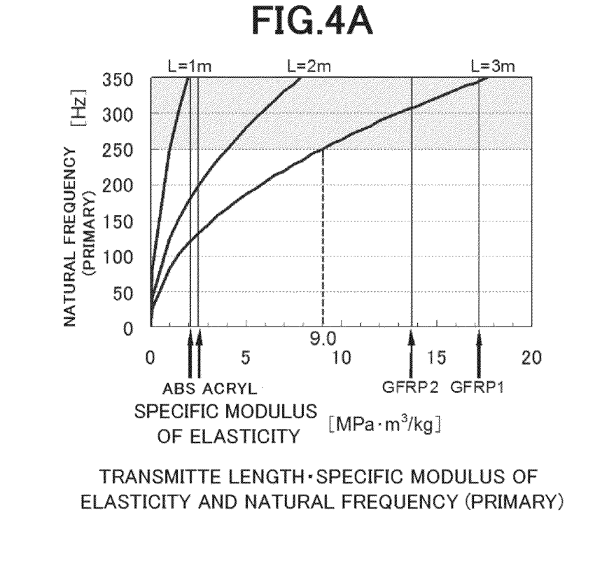

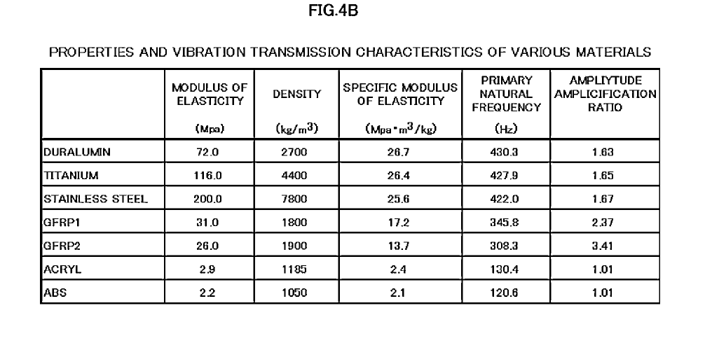

FIG. 4A is a drawing illustrating the relationship between the specific modulus of elasticity and the primary natural frequency found from Expression 3 for lengths L=1, 2 and 3 m. For example, when L=3 m, by selecting a material having a specific modulus of elasticity of 9 MPa·m³/kg or greater, the primary natural frequency exceeds the upper frequency limit of 250 Hz when the excitation frequency band is taken to be 250 Hz or less, so it is possible to prevent damage due to resonance of the transmitter 120.

Next, the condition that, (3) the material is a non-magnetic material, will be explained. The reason for this, is that when the material of the transmitter 120 is ferromagnetic material, it is attracted toward the magnetostatic field of the MRI apparatus 200. Moreover, it is further preferred that the material of the transmitter 120 be a non-metallic material. Even in the case where the material is a non-magnetic metal, when the transmitter 120 is caused to vibrate inside the magnetostatic field, an eddy current occurs inside the metal body due to electromagnetic induction. There is a possibility that a magnetic field will be generated due to this eddy current, and will affect the magnetostatic field of the MRI apparatus 200.

Next, FIGS. 4A and 4B will be used to explain in detail how to determine the material of the transmitter 120 based on the conditions (1) to (3) explained above. In the following explanation, as an example, the case in which the excitation frequency band is 50 to 250 Hz, and the length of the transmitter 120 is 3 m will be explained. FIG. 4A is a drawing illustrating the relationship between the specific modulus of elasticity and the primary natural frequency resulting from Expression 3, and FIG. 4B illustrates the physical properties and the vibration transmission characteristics of various materials. First, for condition (1), the material listed in FIG. 4A and FIG. 4B satisfy this condition. Moreover, from the aspect of condition (2), ABS (Acrylonitrile Butadiene Styrene) and acryl are not appropriate, because the primary natural frequency is within the excitation frequency band. Furthermore, for condition (3), stainless steel, titanium and duralumin, which are non-magnetic, satisfy this condition. As was described above, there is a possibility of affecting the magnetostatic field inside the gantry 210 of the MRI apparatus 200, so that preferably the transmitter 120 is made of a non-metallic material. Therefore, in the MRE excitation apparatus 100 of this embodiment, preferably the material of the transmitter 120 is GFRP (Glass Fiber Reinforced Plastic). However, material suitable for the transmitter 120 is not limited to this, and as long as the material satisfies the conditions (1) to (3) above, it is possible to select any suitable material according to the excitation frequency band, amplitude amplification factor and length of the transmitter 120 and the like.

The support 130 is located between the end-section 121 on the excitation device side of the transmitter 120 and the end-section 122 on the test object side, and supports the transmitter 120 so that the transmitter 120 can transmit longitudinal vibration. Moreover, the support 130 suppresses transverse vibration that occurs due to the weight of the transmitter 120.

Here, for a model that is the same as that in the case of longitudinal vibration described above, the natural frequency of the transverse vibration of the transmitter 120 is expressed by the following expression.

$${f}_{n} = \frac{1}{2 π} \frac{{λ}_{n}^{2}}{{L}^{2}} \sqrt{\frac{EI}{ρ A}} = \frac{{λ}_{n}^{2}}{8 π} \frac{1}{{L}^{2}} \sqrt{\frac{E}{ρ}} \sqrt{{d}^{2} + {d}_{i}^{2}} \\ ( λ = 4.730 , 7.853 … ) \qquad [ Expression 4 ]$$

As illustrated in Expression 4, the natural frequency of the transverse vibration is expressed as a function of the length L, specific modulus of elasticity E/ρ, outer diameter d and inner diameter dᵢ. Here, fundamentally, it is necessary to determine the material of the transmitter 120 so that both the natural frequency of this transverse vibration and the natural frequency of the longitudinal vibration described above are outside the excitation frequency band. However, for example, in the case of a model where the material of the transmitter 120 is GFRP (modulus of elasticity E=31 GPa, density ρ=1800 kg/m³), and is a hollow cylinder having an outer diameter d=10 mm and inner diameter dᵢ=8 mm, the primary natural frequency of the transverse vibration is 3.6 Hz. In this way, the primary natural frequency of the transverse vibration is very low, and it is difficult to make that primary natural frequency outside the excitation frequency band. Therefore, in this embodiment, the transverse vibration is absorbed and suppressed by the support 130 supporting the transmitter 120.

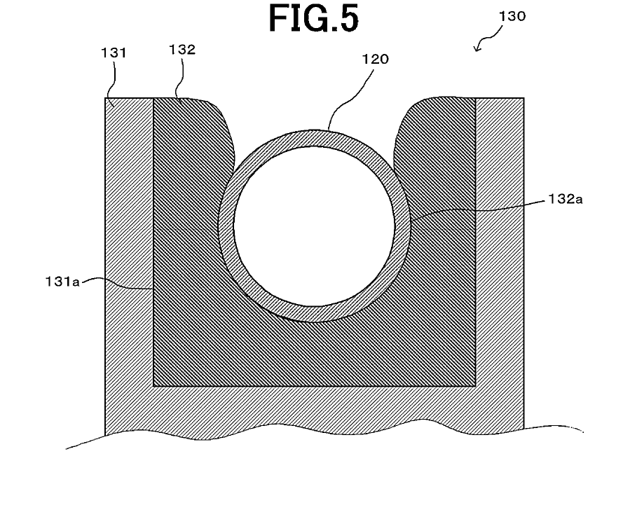

Next, the detailed construction of the support 130 will be explained. The support 130, as illustrated in FIG. 2 and FIG. 5, for example, comprises a column 131 that extends upward from the floor, and a holder 132 that is provided on the top end-section. The column 131 is made of an acrylic resin that is non-magnetic for example, and an upward facing concave section 131a having a U-shaped cross section is formed in the top end-section of that column section 131. The column 131 supports the transmitter 120 by way of the holder 132 that is provided inside this concave section 131a.

The holder 132 is for holding the transmitter 120. The holder 132, for example, as illustrated in FIG. 5, has a curved surface 132a that comes in contact around part of the circumferential surface of the transmitter 120. Moreover, the holder 132 is made of a non-magnetic material such as urethane resin.

Furthermore, the holder 132 is preferably a viscoelastic member that is capable of suitably transmitting longitudinal vibration and absorbing transverse vibration. In this case, due to the elastic component of the holder 132, the holder 132 itself deforms and allows displacement in the axial direction of the transmitter 120, so it is possible to suppress damping of the longitudinal vibration. Therefore, chattering vibration cause by friction, which becomes a problem in normal contact support, does not occur, and thus there is an advantage in that disorder in the waveform of the longitudinal vibration that is caused by that chattering vibration does not occur. Moreover, due to the viscoelastic component of the holder 132, it is possible to effectively absorb and suppress transverse vibration that occurs in the transmitter 120. As the material for the holder 132, a soft material, such as soft urethane or sponge, is preferred.

In FIG. 1, the transmitter 120 is supported by two supports 130, however, the number of supports 130 is not limited to this. The greater the number of supports 130, the more the transverse vibration can be absorbed and suppressed.

The operation during excitation of the MRE excitation apparatus 100, which is constructed as described above, will be explained. In MRE measurement, the excitation device 110 is controlled so that a vibration having a specified frequency in the excitation frequency band (for example, 50 to 250 Hz) and a specified amplitude (for example, 0.25 mm) is outputted. The end-section 121 on the excitation device side of the transmitter 120, which extends in the direction of vibration, is excited by the vibration generated by the excitation device 110. Longitudinal vibration of the transmitter 120 that is generated by the excitation of the end-section 121 on the excitation device side is transmitted to the living body 300 by way of the end-section 122 on the test object side. During this time, due to the amplitude amplification phenomenon described above, the amplitude of the longitudinal vibration, which is transmitted to the living body 300 by way of the end-section 122 on the test object side, is transmitted without being dampened. Moreover, the primary natural frequency of the transmitter 120 is further on the high side than the excitation frequency band, so that there is no damage to the transmitter 120 due to resonance. Furthermore, transverse vibration that is generated in the transmitter 120 is absorbed and suppressed by the holder 132 of the support 130.

With this kind of construction, the MRE excitation apparatus 100 of this embodiment is able to transmit vibration, which is generated by an excitation device 110, to a body 300 as longitudinal vibration without being dampened by way of a transmitter 120 that is made using a non-magnetic material and that has a primary natural frequency that is further on the higher side than the excitation frequency band. Therefore, in MRE measurement, it is possible to excite a test object with sufficient excitation amplitude. Moreover, by absorbing and suppressing transverse vibration while at the same time allowing longitudinal vibration in the support 130, it is possible to output vibration having little noise to the living body 300.

Furthermore, in the MRE excitation apparatus 100 of this embodiment, the transmitter 120 is made using a non-metallic material, so that the magnetostatic field of the MRI apparatus 200 is not affected even when the transmitter 120 vibrates.

In the MRE excitation apparatus 100 of this embodiment, the transmitter 120 is made using a GFRP material, so that it is possible to transmit longitudinal vibration, having an amplitude that is suitably amplified, to the living body 300 without affecting the magnetostatic field generated by the MRI apparatus 200.

Moreover, in the MRE excitation apparatus 100 of this embodiment, the support 130 is made using a soft material and has a holder 132 that holds the transmitter 120, so it is possible to suitably absorb and suppress transverse vibration in the transmitter 120.

The present invention is not limited to the embodiment described above, and various modifications and applications are possible. For example, as illustrated in FIG. 1, the end-section 122 on the test object side of the transmitter 120, is connected to the living body 300 by a belt 123 that is placed around the abdominal area of the living body 300. However, the connection method is not limited to this, and as long as it is possible to transmit the longitudinal vibration of the transmitter 120 to the living body 300, the connection method can be appropriately changed according the measurement site on the living body 300. For example, when the head area of the living body 300 is to be measured, it is possible to fasten the other end-section of the transmitter 120 to a helmet fitted to the living body 300, and to transmit the longitudinal vibration to the head of the living body 300 by way of the helmet.

Moreover, in this embodiment, the case of providing a support 130 that supports the transmitter 120 and that is located between one end-section and the other end-section of the transmitter 120 was explained, however, it is also possible for the transmitter to be supported by the excitation device 110 and the belt 123 without providing a support 130.

Furthermore, in this embodiment, the case of using a living body 300 as the test object was explained, however, as long as the test object is an object having a low modulus of elasticity, the test object could be, but is not limited to, an object such as a biological sample such as an organ, a polymer gel, a food such as konnyaku, agar and the like.

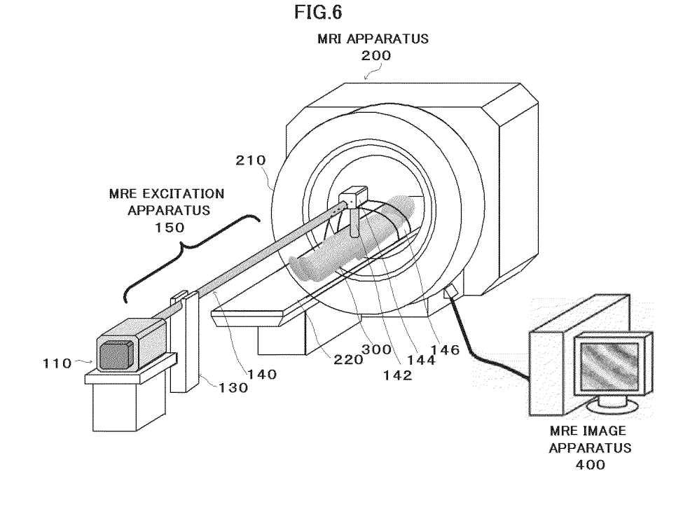

In this embodiment, as illustrated in FIG. 1, a case that a vibration generated by an excitation device 110 is linearly transmitted to a living body 300 by way of a transmitter 120 and the living body 300 is excited by the vibration was explained; however, the transmission direction for transmitting the vibration is not limited to a linear direction, and it is possible for the transmission direction for transmitting the vibration to change en route. For example, the MRE excitation apparatus 150 is not limited to the following components; however, as illustrated in FIG. 6, can also comprise a transmitter 140 that is made using a non-magnetic material and that extends along the direction that the vibration is generated from the excitation device 110, a direction changer 144, a transmitter 142 on the test object side that is made using a non-magnetic material and that extends at an angle that is different than the direction in which the transmitter 140 extends, and a support 130 that is located between one end-section and the other end-section of the transmitter 140 and that supports the transmitter 140. It is also possible to have a support 146 having an arch shape, for example, that supports the direction changer 144, and to provide that support 146 between the bed 220 and the direction changer 144. The support 146, for example, as illustrated in FIG. 6, is provided so that the bottom section of the support 146 comes in contact with the top surface of the bed 220, and the top section of the arch shape of the support 146 comes in contact with the bottom surface of the direction changer 144. The transmitter 142 on the test object side comprises a test object excitation probe that is provided on the tip end thereof. As the material for the support 146, it is possible to use, for example, a fiber reinforced plastic (FRP).

In the form illustrated in FIG. 6, one end-section of the transmitter 140 is fastened to the excitation device 110, and the other end-section of the transmitter 140 is connected to the direction changer 144. The transmitter 140 has the function of transmitting longitudinal vibration from the excitation device 110 to the direction changer 144. The direction changer 144 has the function of changing the direction of the longitudinal vibration that is transmitted by way of the transmitter 140 to a substantial perpendicular direction, and transmitting the longitudinal vibration to the transmitter 142 on the test object side. The transmitter 142 on the test object side has the function of a test object excitation probe provided on the tip end thereof connecting to the test object (living body 300), and transmitting the longitudinal vibration to the test object. The other construction and functions are the same as the construction and functions of the MRE excitation apparatus 100 illustrated in FIG. 1, so a detailed explanation is omitted.

The material of the transmitter 140 and the transmitter 142 on the test object side is the same as that of the transmitter 120 described above, and is appropriately selected so as to satisfy the following three conditions: (1) capable of transmitting longitudinal vibration from the excitation device 110 to the living body 300 without the vibration being dampened, (2) the primary natural frequency of the longitudinal wave is on the high side from the excitation frequency band, and (3) the material is non-magnetic.

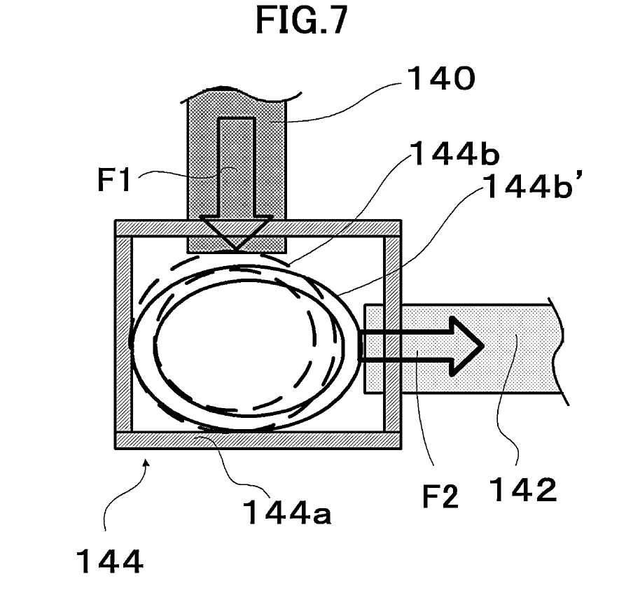

The direction changer 144 comprises a housing 144a and a changer 144b. FIG. 7 is a cross-sectional drawing illustrating the direction changer 144 and the method of changing the direction of the longitudinal vibration. In FIG. 7, the shape (ring shape) of the direction changer before the longitudinal vibration is transmitted to the direction changer is illustrated with dashed lines (144b), and the shape of the direction changer when changing the direction of the longitudinal vibration is illustrated by the solid line (144b′).

As illustrated in FIG. 7, the changer 144b is pressed in the direction of the arrow F1 by the longitudinal vibration that is transmitted from the transmitter 140 and that advances in the direction indicated by the arrow F1. The pressed changer 144b deforms as illustrated in FIG. 7, and the direction of the longitudinal vibration is changed to the direction indicated by the arrow F2 by being constrained between the changer 144b and the housing 144a, and is then transmitted to the transmitter 142 on the test object side.

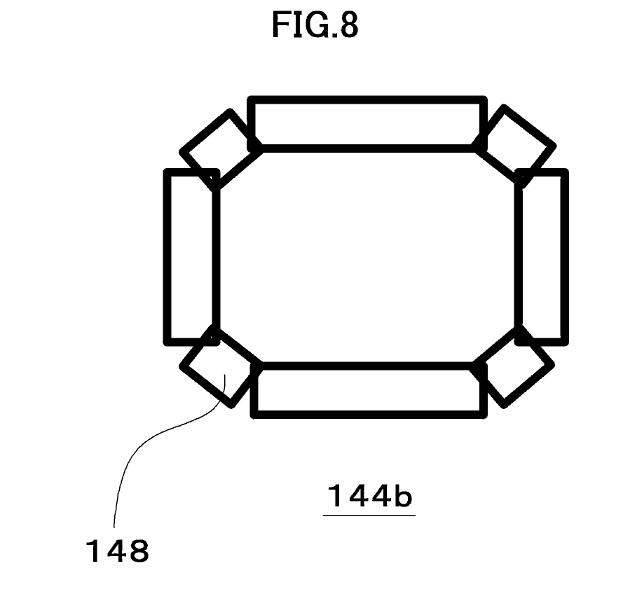

In FIG. 7, a form in which the shape of the changer 144b is a ring-shaped single member is explained; however, the shape can be appropriately selected within a range that allows for the function described above; for example, a polygonal shape or the like that comprises a hinge 148 such as illustrated in FIG. 8 is also possible. Moreover, characteristics, such as rigidity, of the changer 144b are also appropriately selected within a range that allows for the function described above.

In FIG. 6, a form in which an arch-shaped support 146 is provided between the bed 220 and the direction changer 144 was explained, however, the shape, material and installation position of the support 146 is appropriately selected within a range that allows for the function described above.

With the direction changer 144, it is possible in the MRE excitation apparatus 150 to easily change the excitation direction of the longitudinal vibration that is generated by the excitation device 110, and thus it becomes possible to reduce loss that occurs when transmitting the longitudinal vibration. Therefore, it is possible to provide a highly precise and strong longitudinal vibration to the living body 300 even when the longitudinal vibration that is generated by the excitation device 110 and transmitted by way of a first transmitter 140 that extends in the substantially horizontal direction excites the living body 300 in a substantially vertical direction. Consequently, even in the case of a site on the living body 300 where it is desired that excitation be in the substantially vertical direction, it is possible to apply excitation with a highly precise and strong longitudinal vibration using an MRE excitation apparatus 150, and thus it is possible to perform good MRE measurement in many different sites.

Furthermore, in the embodiment illustrated in FIG. 6, the case in which the angle between the transmitter 140 and the transmitter 142 on the test object side is substantially a right angle was explained; however, as long as the angle is within a range that allows for the function described above, it is possible for the angle between the transmitter 140 and the transmitter 142 on the test object side to be an angle other than a substantially right angle. Furthermore, in the embodiment illustrated in FIG. 6, the case in which only one direction changer 144 is used was explained; however, it is also possible to provide two or more direction changers.

In this embodiment, an aspect in which a support 130 or the like was used was explained, however, in other aspects, an MRE excitation system that excites a test object during MRE measurement and that comprises an excitation device that generates vibration, and a transmitter that transmits longitudinal vibration from the excitation device to a test object is also possible. In an MRE excitation system, in order to minimize variation in the measurement values of the modulus of elasticity in the measured area in a test object, the frequency and amplitude of the longitudinal vibration that is generated by the excitation device are controlled. Moreover, in an MRE excitation system, as in the case of an MRE excitation apparatus 100, the primary natural frequency of the longitudinal vibration of the transmitter is further on the high side than the frequency of the vibration from the excitation device.

For a frequency and amplitude of the longitudinal vibration which minimizes variation in the measurement values of the modulus of elasticity in a measured area of a test object, preferably a longitudinal vibration is selected such that the frequency is in the range 125 to 500 Hz, and the amplitude is in the range 0.2 to 2.0 mm. More preferably a longitudinal vibration is selected such that the frequency is in the range 125 to 250 Hz, and the amplitude is in the range 0.2 to 1.0 mm. Even more preferably, a longitudinal vibration is selected such that the frequency is in the range 125 to 250 Hz, and the amplitude is in the range 0.2 to 0.5 mm, and yet even more preferably, a longitudinal vibration is selected such that the frequency is 250 Hz, and the amplitude is 0.5 mm. Therefore, preferably, when a longitudinal vibration having a frequency of 125 to 500 Hz and an amplitude of 0.2 to 2.0 mm, and more preferably, a longitudinal vibration having a frequency of 125 to 250 Hz and an amplitude of 0.2 to 1.0 mm, and even more preferably, a longitudinal vibration having a frequency of 125 to 250 Hz and an amplitude of 0.2 to 0.5 mm, and yet even more preferably, a longitudinal vibration having a frequency of 250 Hz and an amplitude of 0.5 mm is selected, the precision of the MRE measurement becomes higher, or in other words, the reliability becomes greater, imaging becomes possible using an MRE image apparatus 400 without the need for special data processing by a computer, and it becomes easier to obtain the elastic property of the living body 300. When the frequency is too high, it becomes difficult to synchronize the phase of the longitudinal vibration and the phase of the Motion Sensitizing Gradient (MSG), so using a longitudinal vibration having a high frequency and large amplitude within a range where it is possible to synchronize the phase of the longitudinal vibration and the MSG phase, where it is possible to transmit the longitudinal vibration a long distance, and where it is possible to measure within deep sections in the test object is even more preferable.

Above, a preferable range, a more preferable range, an even more preferable range and yet an even more preferable range for the frequency and amplitude of the longitudinal vibration were explained; however, the frequency and amplitude of the longitudinal vibration that is generated by the excitation device 110 can be appropriately selected within a range where it is possible to transmit the longitudinal vibration a long distance, where it is possible to measure sections including within deep sections in the test object, and where it is possible to obtain an image with the MRE image apparatus 400 without the need for special data processing by a computer, and where it is possible to easily obtain the elastic property of the living body 300. For example, including but not limited to the following, it is possible to select a longitudinal vibration having a frequency of 62.5 Hz and an amplitude of 5.0 mm, or to select a longitudinal vibration having a frequency of 300 Hz and an amplitude of 0.3 mm.

The frequency and amplitude of the longitudinal vibration can be controlled manually, or can be controlled automatically. In the case where control is performed manually, the user adjusts the frequency and amplitude of the longitudinal vibration of an alternating current that is supplied to the excitation device 110 while monitoring the condition of the variation in the modulus of elasticity that appears in the image of the MRE image apparatus 400.

Moreover, when the frequency and amplitude of the longitudinal vibration are controlled automatically, control is performed such as described in the following.

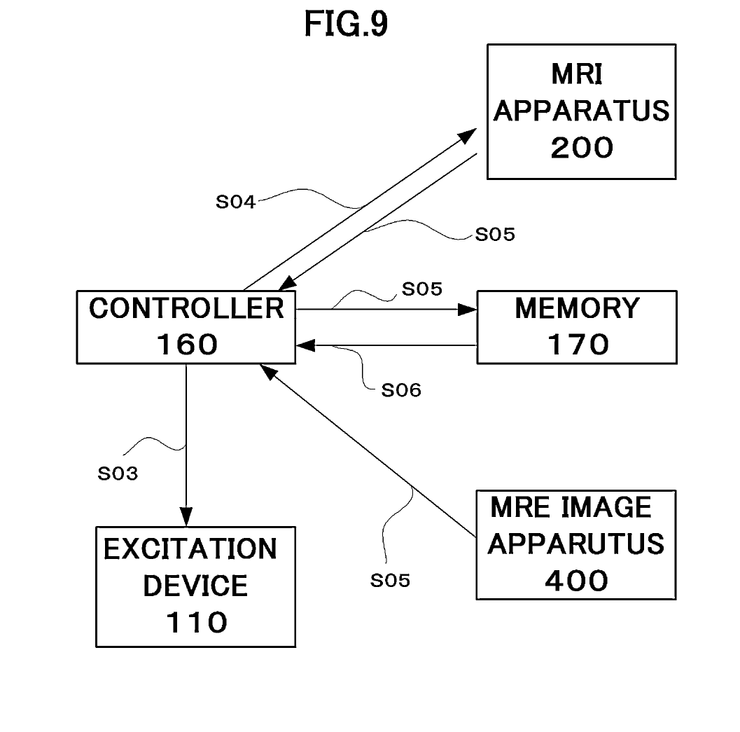

As illustrated in FIG. 9, there is a controller 160 that sets the operation parameters for the excitation device 110 and MRI apparatus 200.

The controller 160 is provided with a CPU (Central Processing Unit), a memory, an input/output device and the like, and sets the operation parameters for the excitation device 110 and MRI apparatus 200 in response to instructions from the user.

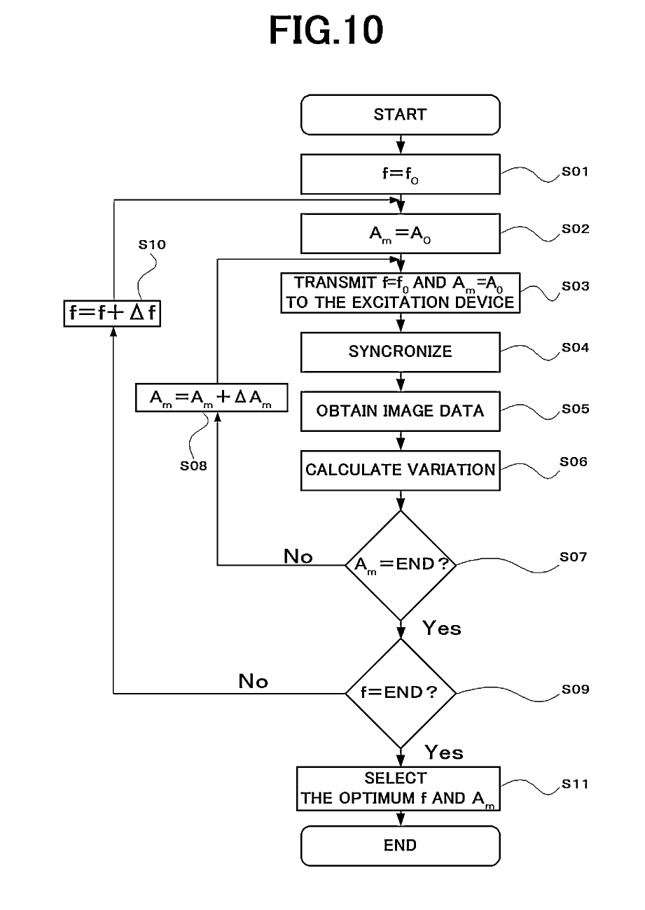

Next, the processing by the controller 160 for controlling the frequency and amplitude of the longitudinal vibration will be explained with reference to FIG. 10.

For example, in response to an instruction from the user to start processing to search for the optimum frequency and amplitude, the controller 160 sets the frequency f of the vibration generated by the excitation device 110 to the lower limit value fₒ of the variable range, for example, 125 Hz (step S01). Next, the controller 160 sets the amplitude Aₘ of the vibration to the minimum value A₀, for example, 0.2 mm (step S02).

The controller 160 then transmits the frequency f and amplitude Aₘ that were set to the excitation device 110, and causes the excitation device 110 to start excitation (step S03).

Next, the controller 160 sets the operation parameters for the MRI apparatus 200 so that the excitation operation and imaging operation of the MRI apparatus 200 is synchronized with the longitudinal vibration generated by the excitation device 110, and starts the excitation operation and imaging operation (step S04). Moreover, the controller 160 sets the resolution of the image to be obtained to a resolution that is lower than the resolution of the image that will finally be obtained.

After the MRI apparatus 200 and MRE image apparatus 400 obtain an image, the controller 160 obtains this image data (voxel data), and saves that data in a memory 170 (step S05).

Next, the controller 160 reads the values of all pixels of the image data stored in the memory 170 (values corresponding to the modulus of elasticity of the site corresponding to the test object), and finds the variation (variance σ² or standard deviation σ). In other words, the controller 160, as a variation calculator, calculates the variation in the modulus of elasticity in a measured area of the test object. The controller 160 stores the calculated variation, together with the frequency f and amplitude Aₘ, in the memory 170 (step S06).

The controller 160 then determines whether or not the amplitude Aₘ has reached an upper limit value, for example, 1.5 mm (step S07), and when it is determined that the amplitude Aₘ has not reached the upper limit value (step S07: NO), the controller 160 adds a minute value ΔAₘ, for example, 0.1 mm, to the amplitude Aₘ (step S08). After that, the controller 160 repeats the processing of step S03 to step S07.

When it is determined that the amplitude Aₘ has reached the upper limit (step S07: YES), the controller 160 then determines whether or not the vibration f has reached an upper limit value, for example, 250 Hz (step S09), and when it is determined that the vibration f has not reached the upper limit value (step S09: NO), the controller 160 adds a minute value Δf, for example, 2.5 Hz, to the frequency f (step S10). After that, the controller 160 repeats the processing of step S02 to step S09.

When it is determined that the frequency f has reached the upper limit value (step S09: YES), the controller 160 then selects the frequency and amplitude for which variation is a minimum (optimum frequency and amplitude) from the variation of the modulus of elasticity, the frequency f and amplitude Aₘ saved in the memory 170 in step S06 (step S11). The frequency and amplitude of the longitudinal vibration are automatically controlled by the steps described above.

Next, with the test object that was used for selecting the optimum frequency and amplitude in step S01 to step S11 in place on the bed as is, the controller 160 transmits the optimum frequency and amplitude to the excitation device 110 and causes excitation to begin. The controller 160 then synchronizes the longitudinal vibration that is generated by the excitation device 110 with the excitation operation and imaging operation by the MRI apparatus 200. Then, MRE measurement is performed in which the MRI apparatus 200 and MRE image apparatus 400 obtain a final image.

Moreover, it is also possible to place a test object that is different than the test object that was used for selecting the optimum frequency and amplitude on the bed, and then have the controller 160 transmit the optimum frequency and amplitude above to the excitation device 110 and cause the excitation device to start excitation, synchronize the longitudinal vibration that is generated by the excitation device 110 with the excitation operation and imaging operation of the MRI apparatus 200, and perform MRE measurement in which the MRI apparatus 200 and MRE image apparatus 400 obtain a final image.

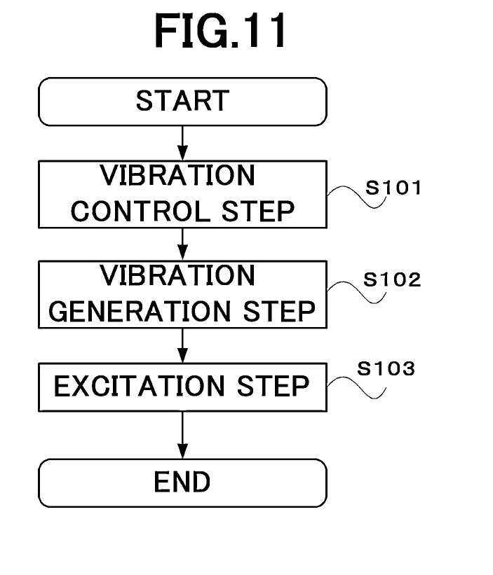

Also, an MRE excitation method that uses the MRE excitation apparatus 100 is performed, for example, as described in the following (FIG. 11).

From step S01 through step S11 described above, the controller 160 automatically controls the frequency and amplitude of the longitudinal vibration (step S101).

The excitation device 110 generates vibration of which the frequency and amplitude have been automatically controlled by step S101 (step S102), transmits a longitudinal vibration to a test object (a living body 300) using a transmitter 120 and a belt 123, and performs MRE excitation of the living body 300 (step S103). Here, steps S102 and S103 can be performed at the same time. It is also possible to manually control the frequency and amplitude of the longitudinal vibration that is generated by the excitation device 110.

Here, the process for performing MRE excitation using an MRE excitation apparatus 100 was explained; however, it is also possible to perform MRE excitation using an MRE excitation apparatus 150, or to perform MRE excitation using an MRE excitation system.

### EXAMPLES

The present invention will be explained in detail using some examples.

### Example 1

In the following, the result of a verification test that was performed for comparing input and output waveforms by the MRE excitation apparatus 100 described above will be explained.

In this example, the excitation frequency band was taken to be 50 to 250 Hz, and a pipe made of GFRP was used as the transmitter 120. This pipe has a length L=3 m, and outer diameter d=10 mm, and inner diameter dᵢ=8 mm, and the primary natural frequency of the longitudinal vibration that is calculated from Expression 3 is 346 Hz. This value was greater than 250 Hz, which is the upper limit of the excitation frequency band.

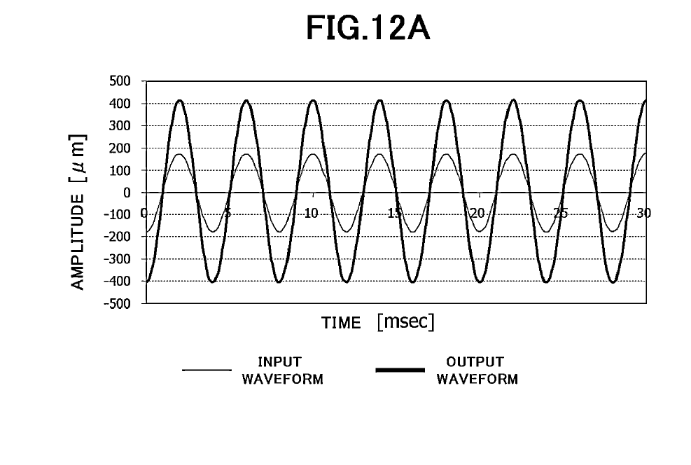

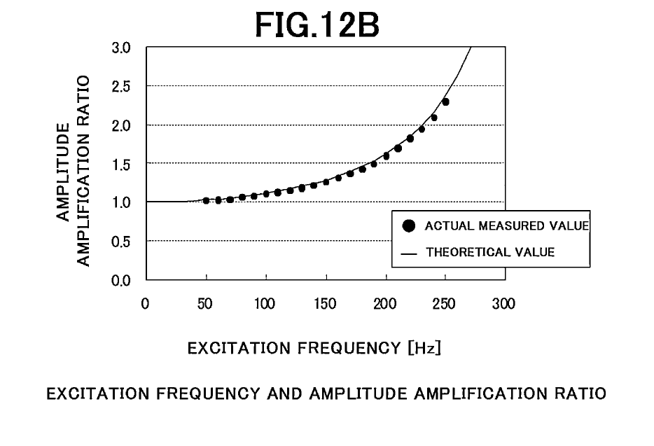

Next, FIG. 12A illustrates the input waveform, and the output waveform at the other end of the pipe, when one end-section of the pipe was excited by an electro-dynamic exciter with an input amplitude of 250 μm and an excitation frequency of 250 Hz. As illustrated in FIG. 12A, it was found that the output waveform was in the same phase with the input waveform and was a sine wave having little noise. FIG. 12B illustrates the measurement results of the amplitude amplification ratio at excitation frequencies from 50 to 250 Hz. As illustrated in FIG. 12B, the amplitude amplification ratio showed a tendency to coincide well with the theoretical value over the entire excitation frequency band.

From the verification test described above, it was found that, in the longitudinal vibration of the end-section 122 on the test object side when the end-section 121 on the excitation device side of the transmitter 120 in this embodiment was excited, the output amplitude was greater than the input amplitude and thus a sufficient output amplitude can be obtained in MRE measurement.

### Example 2

In the following, test results that illustrate direction change by the direction changer 144 will be explained.

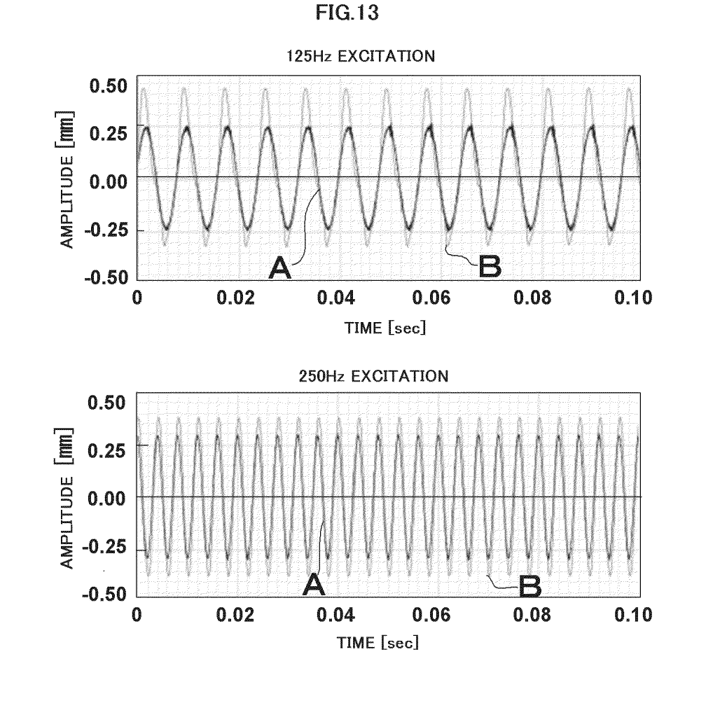

FIG. 13 is a drawing illustrating the waveforms of 125 Hz and 250 Hz vibrations before and after direction change. Two accelerometers for measuring the response before direction change and after direction change were used, and data processing was performed with measurement software LabVIEW (National Instruments Corporation). In FIG. 13, vibration on the input side that was generated by the excitation device 110 and transmitted to the changer 144b by way of the transmitter 140 (direction before change) is illustrated by the dark colored line (line A), and the vibration on the output side for which direction has been changed by the changer 144b (direction after change) is illustrated by the gray color line (line B). As illustrated in FIG. 13, line A (input side) and line B (output side) are in the same phase, and the amplitude of the output side is amplified and is greater than the amplitude on the input side. Therefore, it was found that when the direction changer 144 was used, the output amplitude was also amplified and was also greater than the input amplitude, and sufficient output amplitude was also obtained for MRE measurement.

### Example 3

In the following, testing of MRE measurement will be explained.

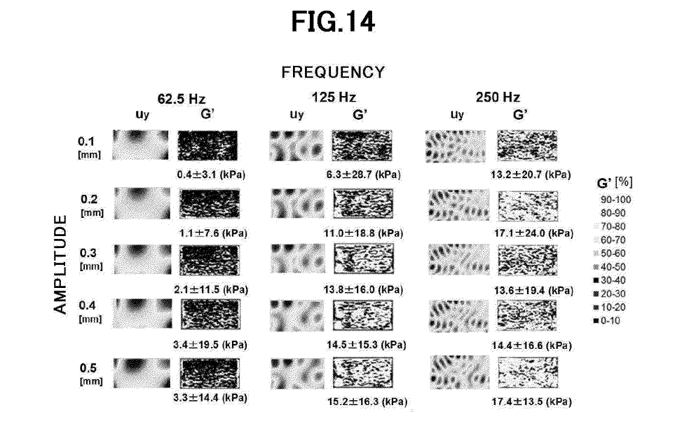

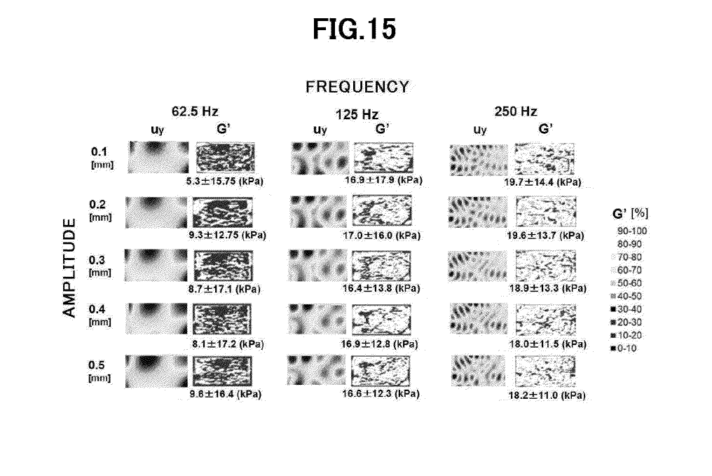

FIG. 14 and FIG. 15 are drawings illustrating the test results of MRE measurement.

The MRE measurement illustrated in FIG. 14 and FIG. 15 was performed using an exciter as described below and under the test conditions also described below. In this test, agarose gel was used instead of a living body 300.

(1) Exciter

Model: C-5015 D-MASTER (Asahi Inc.)

Excitation source: Electro-dynamic

Excitation direction: Longitudinal

Frequency range: 1 to 500 Hertz (Hz)

Displacement: 0 to 15 (mm p-p)

Maximum load: 2 (kg)

Acceleration: 490 (m/s²)

(2) Test Conditions

### (Measured Object)

Material: Agarose gel (1.2% by weight, 50 mm×130 mm×40 mm)

Boundary condition: Base surface (fixed), other surfaces (free)

### (Transmitter)

Material: GFRP

Length: 2 m

### (Oscillatory Waves)

Wave pattern: Sine wave

Direction: Y direction (longitudinal direction)

Frequency: 62.5 Hz, 125 Hz, 250 Hz

Amplitude: 0.1 mm, 0.2 mm, 0.3 mm, 0.4 mm, 0.5 mm

### (Micro MRI Apparatus)

Model: Compact MRI (MRTechnology, Inc.)

Magneto-static field: 0.3 Tesla

Magnet type: Permanent magnet

RF coil size: 125 mm×280 mm×65 mm (measurement zone)

Magnetic field homogeneity space: SR 50 mm

Gradient magnetic field: (Gₓ, G_{y}, G_{z})=(18, 18, 28) mT/m

### (Magnetic Resonance Image)

Sequence: Spin echo

Image size: 128 pixels×256 pixels

Resolution: 1.2 (mm/pixel)

MSG timing: Phase difference with the vibration is 0, π/2, π, 3π/2

The relationship between the storage modulus of elasticity at each measurement point in MRE measurement, the average value of the values for the storage modulus of elasticity at all measurement points, and the variation in the storage modulus of elasticity at each measurement point is expressed by the following expression.

$${G}^{′} = ( 1 - \vert \frac{G - \overline{G}}{\overline{G}} \vert ) \times 100 [ \% ] \\ where , \\ G \text{:} \begin{matrix}Storage modulus of \\ elasticity at each measurement point\end{matrix} \\ \overline{G} \text{:} \begin{matrix}Average storage modulus of \\ elasticity of all measurement points\end{matrix} \\ {G}^{′} \text{:} \begin{matrix}Variation in the storage modulus of \\ elasticity at each measurement point\end{matrix} \qquad [ Expression 5 ]$$

In FIG. 14 and FIG. 15, u_{y} indicates displacement in the y direction. FIG. 14 illustrates images when noise removal processing has not been performed, and FIG. 15 illustrates images when noise removal processing has been performed.

In this example, the measured object is presumed to be a uniform object, so when the value of G is the same for all measurement points, the difference between the average values is zero, and G′ for all of the measurement points becomes 100%, so that in the images in FIG. 14 and FIG. 15, there are only white areas. The G′ images in FIG. 14 and FIG. 15 illustrate that the larger the area of light color there is, the smaller the variation in data is, and the larger the area of dark color there is, the larger the variation in data becomes. Here, the less the variation in data is, the higher the precision of MRE measurement and greater the reliability becomes, so the precision of MRE measurement becomes higher and the reliability becomes greater at a frequencies and amplitudes that result in larger areas of light color.

From the distribution of light color areas in the G′ images at each condition in FIG. 14 and FIG. 15, it was found that when the longitudinal vibration was controlled so that frequency was within the range 125 to 250 Hz, and the amplitude was within the range of 0.2 to 0.5 mm, variation in the data could be made even less. Therefore, from FIG. 14 and FIG. 15, when the longitudinal vibration is controlled so that the frequency is 125 to 250 Hz and the amplitude is 0.2 to 0.5 mm, the test object is excited during MRE measurement with a sufficient excitation amplitude, the precision of MRE measurement becomes higher, or in other words, the reliability becomes greater, so that it is possible to obtain an image with the MRE image apparatus 400 without the need for special data processing by a computer, and to more easily obtain the elastic property of the living body 300.

The present invention is not limited to the embodiments described above, and various modifications and applications are possible.

Part or all of the embodiments above and the examples above are described in the supplementary notes below, however, are not limited to the following.

(Supplementary Note 1)

An MRE Excitation apparatus that excites a test object during MRE measurement, comprises:

an excitation device that generates vibration;

a transmitter that is made using a non-magnetic material that, with one end-section being fastened to the excitation device and the other end-section connecting to the test object, extends along the direction of vibration from the excitation device and transmits longitudinal vibration from the excitation device to the test object; and

a support that is located between the one end-section and the other end-section of the transmitter, and that supports the transmitter; wherein

the primary natural frequency of the longitudinal vibration of the transmitter is outside the frequency band of the vibration from the excitation device.

(Supplementary Note 2)

The MRE excitation apparatus according to Supplementary note 1, wherein the transmitter is made using a non-metallic material.

(Supplementary Note 3)

The MRE excitation apparatus according to Supplementary note 1 or Supplementary note 2, wherein the transmitter is made using a GFRP material.

(Supplementary Note 4)

The MRE excitation apparatus according to any one of the Supplementary notes 1 to 3, wherein the support is made using a soft material, and has holder that holds the transmitter.

This application is based on Japanese Patent Application No. 2010-188514 filed on Aug. 25, 2010 and including specification, claims, drawings and summary. The disclosure of the above Japanese Patent Application No. 2010-188514 is incorporated herein by reference in its entirety.

### REFERENCE SIGNS LIST

100 MRE excitation apparatus
110 Excitation device
120 Transmitter
121 End-section on the excitation device side
122 End-section on the test object side
123 Belt
130 Support
131 Column
131a Concave section
132 Holder
132a Curved surface
140 Transmitter
142 Transmitter on the test object side
144 Direction changer
144a Housing
144b Changer
146 Support
148 Hinge
150 MRE excitation apparatus
160 Controller
170 Memory
200 MRI apparatus
210 Gantry
220 Bed
300 Living body
400 MRE image apparatus

1. An MRE excitation apparatus that excites a test object during MRE measurement, comprising:
an excitation device that generates vibration; and
a transmitter that is made using a non-magnetic material and that, with one end-section being fastened to the excitation device and the other end-section connecting to the test object, extends along the direction of vibration from the excitation device and transmits longitudinal vibration from the excitation device to the test object; wherein
the frequency of the vibration is 125 Hz or greater;
the amplitude of the vibration is 0.2 mm or greater; and
the primary natural frequency of the longitudinal vibration of the transmitter is further on the high side than the frequency band of the vibration from the excitation device; and
the MRE excitation apparatus further comprises a support that is located between the one end-section and the other end-section of the transmitter, and that supports the transmitter.

2. An MRE excitation apparatus that excites a test object during MRE measurement, comprising:
an excitation device that generates vibration;
a transmitter that is made using a non-magnetic material and that extends along the direction that vibration is transmitted from the excitation device;
at least one direction changer; and
a transmitter on the test object side that is made using a non-magnetic material and that extends in an angle different than the direction that the transmitter extends; wherein
the one end-section of the transmitter is fastened to the excitation device, the other end-section of the transmitter is connected to the direction changer, and the transmitter transmits longitudinal vibration from the excitation device to the direction changer;
the direction changer changes the direction of the longitudinal vibration that is transmitted by the transmitter, and transmits the longitudinal vibration to the transmitter on the test object side;
the transmitter on the test object side is connected with the test object, and transmits the longitudinal vibration to the test object;
the frequency of the vibration is 125 Hz or greater;
the amplitude of the vibration is 0.2 mm or greater; and
the primary natural frequency of the longitudinal vibration of the transmitter and the transmitter on the test object side is further on the high side than the frequency band of the vibration from the excitation device; and
the MRE excitation apparatus further comprises a support that is located between the one end-section and the other end-section of the transmitter, and that supports the transmitter.

3. The MRE excitation apparatus according to claim 1, wherein the transmitter is made using a non-metallic material.

4. The MRE excitation apparatus according to claim 1, wherein the transmitter is made using a GFRP material.

5. (canceled)

6. The MRE excitation apparatus according to claim 1, wherein the support is made using a soft material, and has a holder that holds the transmitter.

7. An MRE excitation system that excites a test object during MRE measurement, comprising:
an excitation device that generates vibration; and
a transmitter that transmits longitudinal vibration from the excitation device to the test object; wherein
the frequency of the vibration is 125 Hz or greater;
the amplitude of the vibration is 0.2 mm or greater;
the primary natural frequency of the longitudinal vibration of the transmitter is further on the high side than the frequency band of the vibration from the excitation device; and
during the MRE measurement, the frequency and amplitude of the longitudinal vibration that is generated by the excitation device is controlled so that variation in measurement values of the modulus of elasticity in the measurement area in the test object is minimized; and
the MRE excitation apparatus further comprises a support that is located between one end-section and the other end-section of the transmitter, and that supports the transmitter.

8. The MRE excitation system according to claim 7 comprising a controller that automatically controls the frequency and amplitude of the vibration.

9. An MRE excitation method comprising:
controlling the frequency and amplitude of longitudinal vibration so that variation in measurement values of modulus of elasticity in a measurement area in a test object is minimized;
generating vibration; and
exciting the test object with the longitudinal vibration; wherein
the frequency of the vibration is 125 Hz or greater; and
the amplitude of the vibration is 0.2 mm or greater.

10. The MRE excitation method according to claim 9, wherein the controlling the frequency and amplitude of the vibration is automatically controlled.

11. The MRE excitation apparatus according to claim 2, wherein the transmitter is made using a non-metallic material.

12. The MRE excitation apparatus according to claim 2, wherein the transmitter is made using a GFRP material.

13. The MRE excitation apparatus according to claim 2, wherein the support is made using a soft material, and has a holder that holds the transmitter.
